(19) United States
(12) Patent Application Publication
(10) Pub. No.: US 2026/0171307 A1
(43) Pub. Date: Jun. 18, 2026

(54) MULTILAYER ELECTRONIC COMPONENT

(71) Applicant: SAMSUNG ELECTRO-MECHANICS CO., LTD., Suwon-si (KR)

(72) Inventors: Pum San CHAE, Suwon-si (KR); Kun Hoi KOO, Suwon-si (KR)

(73) Assignee: SAMSUNG ELECTRO-MECHANICS CO., LTD., Suwon-si (KR)

(21) Appl. No.: 19/402,248

(22) Filed: Nov. 26, 2025

(30) Foreign Application Priority Data
Dec. 18, 2024 (KR) 10-2024-0190301

(51) Int. Cl. H01G 2/10; H01G 4/252; H01G 4/30

(52) U.S. Cl. CPC H01G 2/103; H01G 4/252; H01G 4/30

(57) ABSTRACT

A multilayer electronic component includes: a body including a dielectric layer and an internal electrode alternately disposed with the dielectric layer; an external electrode disposed on the body and connected to the internal electrode; and an organic layer disposed on at least a portion of an external surface of the body and at least a portion of an external surface of the external electrode, and including an organic silicon compound, and in at least a portion of a region of the organic layer disposed on the body, a content of Si element measured by X-ray photoelectron spectroscopy (XPS) may be 2.2 at % or more and 5.8 at % or less.

### CROSS-REFERENCE TO RELATED APPLICATION(S)

This application claims benefit of priority to Korean Patent Application No. 10-2024-0190301 filed on Dec. 18, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-shaped capacitor mounted on the printed circuit boards of various types of electronic products such as video devices such as Liquid Crystal Display (LCD) and Plasma Display Panel (PDP), computers, smartphones and mobile phones, and the circuits of the onboard charger (OBC) DC-DC converter of electric vehicles, and the like, and playing a role in charging or discharging electricity.

In the case of high-voltage multilayer ceramic capacitors used in electronic components, and the like, there is a concern that an arc discharge phenomenon in which current flows between external electrodes having different polarities through a surface of the multilayer ceramic capacitor may occur. As one method of suppressing the arc discharge phenomenon of the multilayer ceramic capacitor, a method of coating the surface of the multilayer ceramic capacitor with a water-repellent agent may be considered. A silane coupling agent may be used as a water-repellent agent for coating the multilayer ceramic capacitor, but it is necessary to suppress the side effects caused by the water-repellent coating.

### REFERENCE

### Patent Document

(Patent Document 1) Japanese Patent Publication No. 2017-135239

### SUMMARY

An aspect of the present disclosure is to provide a multilayer electronic component having excellent reliability.

However, the aspects of the present disclosure are not limited to the above-described contents, and may be more easily understood in the process of describing specific embodiments of the present disclosure.

A multilayer electronic component according to an example embodiment of the present disclosure may include: a body including a dielectric layer and an internal electrode alternately disposed with the dielectric layer; an external electrode disposed on the body and connected to the internal electrode; and an organic layer disposed on at least a portion of an external surface of the body and at least a portion of an external surface of the external electrode, and including an organic silicon compound, and in at least a portion of a region of the organic layer disposed on the body, a content of Si element measured by X-ray photoelectron spectroscopy (XPS) may be 2.2 at % or more and 5.8 at % or less.

As one effect of the present disclosure, a multilayer electronic component with excellent reliability may be provided.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an example embodiment of the present disclosure;

FIG. 2 is a perspective view schematically illustrating the appearance of a body and an external electrode, with the organic layer removed from FIG. 1;

FIG. 3 is a cross-sectional view schematically illustrating a cross-section taken along line I-I′ of FIG. 1;

FIG. 4 is a cross-sectional view schematically illustrating a cross-section taken along line II-II′ of FIG. 1;

FIG. 5 is an enlarged view schematically illustrating region K1 of FIG. 3;

FIG. 6 is an enlarged view schematically illustrating region K2 of FIG. 3; and

FIG. 7 is a schematic diagram schematically illustrating a process of forming an organic layer.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to more completely explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

In the drawing, A first direction (x-direction) may be defined as a thickness (T) direction, a second direction (Y-direction) may be defined as a length (L) direction, and a third direction (Z-direction) may be defined as a width (W) direction.

### Multilayer Electronic Component

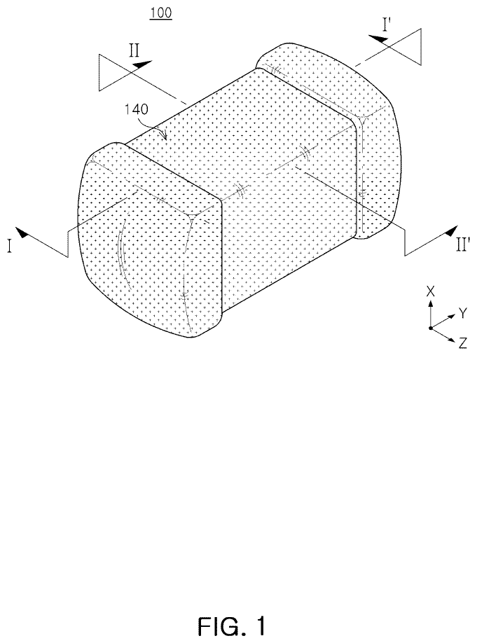

FIG. 1 is a perspective view schematically illustrating a multilayer electronic component according to an example embodiment of the present disclosure.

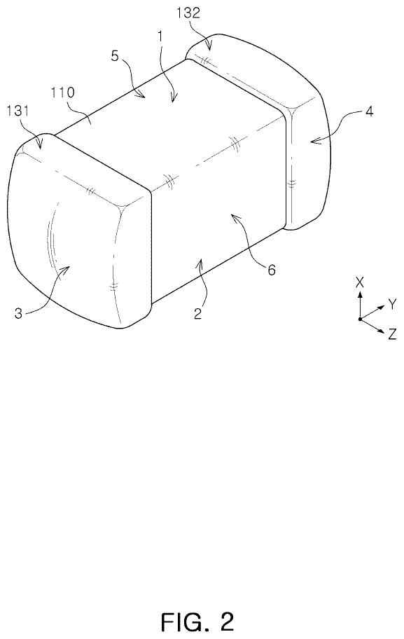

FIG. 2 is a perspective view schematically illustrating the appearance of a body and an external electrode, with the organic layer removed from FIG. 1.

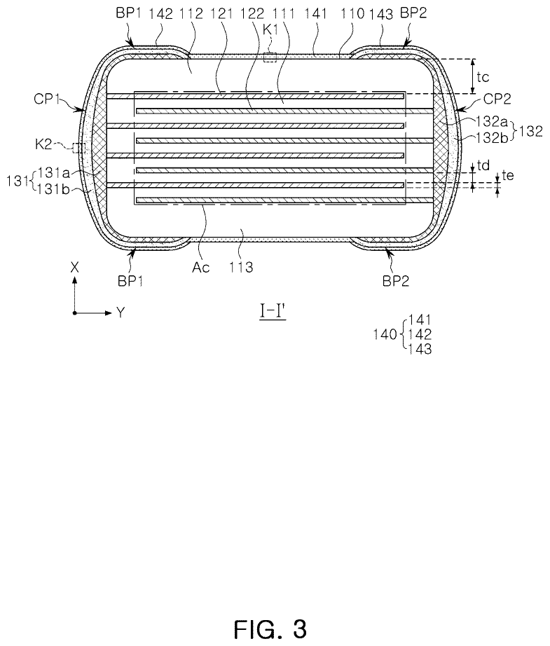

FIG. 3 is a cross-sectional view schematically illustrating a cross-section taken along line I-I′ of FIG. 1.

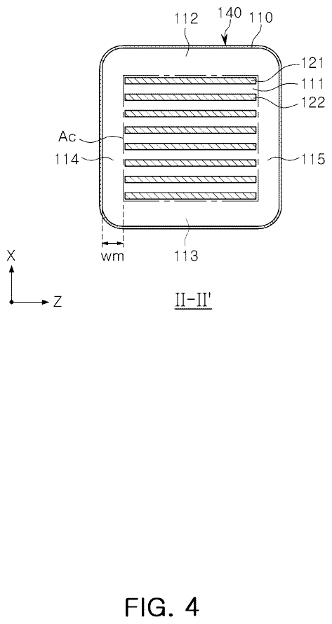

FIG. 4 is a cross-sectional view schematically illustrating a cross-section taken along line II-II′ of FIG. 1.

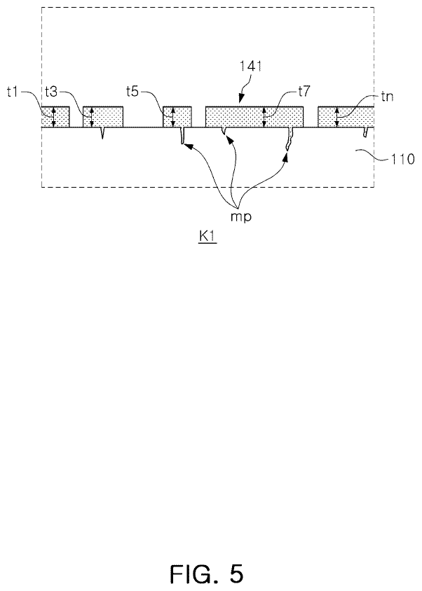

FIG. 5 is an enlarged view schematically illustrating region K1 of FIG. 3.

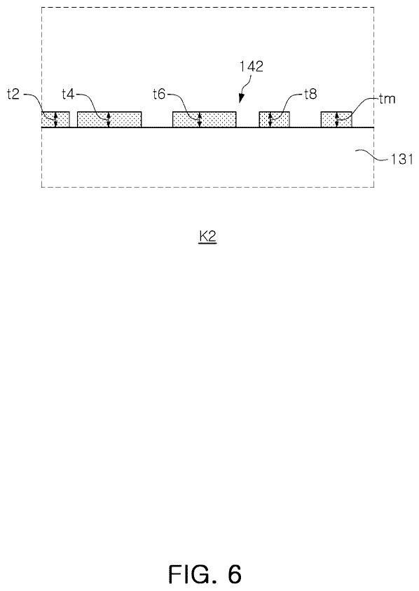

FIG. 6 is an enlarged view schematically illustrating region K2 of FIG. 3.

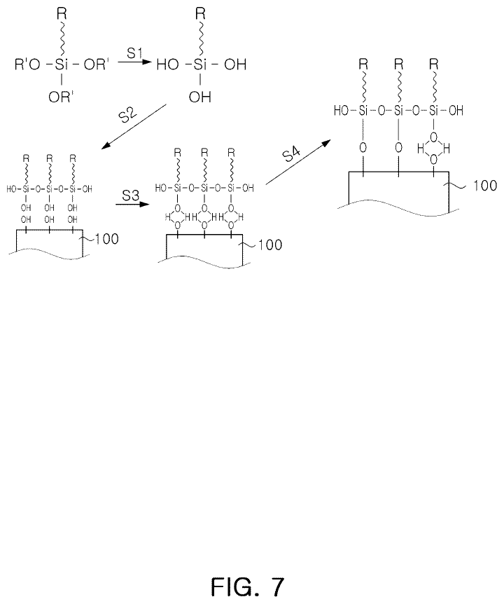

FIG. 7 is a schematic diagram schematically illustrating a process of forming an organic layer.

Hereinafter, a multilayer electronic component 100 according to an embodiment of the present disclosure will be described in detail with reference to FIGS. 1 to 7. Additionally, a multilayer ceramic capacitor will be described as an example of a multilayer electronic component, but the present disclosure is not limited thereto and may be applied to various multilayer electronic components, for example, an inductor, a piezoelectric element, a varistor, or a thermistor.

The multilayer electronic component 100 according to an embodiment of the present disclosure may include a body 110 including a dielectric layer 111 and internal electrodes 121 and 122, external electrodes 131 and 132, and an organic layer 140.

There is no particular limitation on a specific shape of the body 110, but as illustrated, the body 110 may be formed in a hexahedral or similar shape. Due to the shrinkage of ceramic powder particles included in the body 110 during a sintering process or a polishing process on the corners of the body 110, the body 110 does not have a hexahedral shape with perfectly straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, fifth and sixth surfaces 5 and 6 connected to the first to fourth surfaces 1, 2, 3 and 4 and opposing each other in the third direction.

The body 110 may include a dielectric layer 111 and internal electrodes 121 and 122 alternately disposed with the dielectric layer 111. A plurality of dielectric layers 111 forming a body 110 are in a sintered state, and boundaries between adjacent dielectric layers 111 may be integrated to be difficult to identify without using a scanning electron microscope (SEM).

The dielectric layer 111 may include, for example, a perovskite-type compound represented by ABO₃ as a main component. The perovskite compound represented by ABO₃ may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ) (Zr_{1-y}Ti_{y})O₃ (0<x≤0.5, 0<y≤0.5).

An average thickness td the dielectric layer 111 is not particularly limited. The average thickness td of the dielectric layer 111 may be, for example, 0.1 μm to 20 μm, 0.1 μm to 10 μm, 0.1 μm to 5 μm, 0.1 μm to 2 μm, or 0.1 μm to 0.4 μm.

The internal electrodes 121 and 122 may include, for example, a first internal electrode 121 and a second internal electrode 122 alternately disposed in a first direction with the dielectric layer 111 interposed therebetween. The first internal electrode 121 and the second internal electrode 122, which are a pair of electrodes having different polarities, may be disposed to face each other with the dielectric layer 111 interposed therebetween.

The first internal electrode 121 may be spaced apart from the fourth surface 4 and connected to the first external electrode 131 on the third surface 3. The second internal electrode 122 may be spaced apart from the third surface 3 and connected to the second external electrode 132 on the fourth surface 4.

The conductive metal included in the internal electrode 121 and 122 may be at least one selected from the group consisting of Ni, Cu, Pd, Ag, Au, Pt, Sn, W, Ti, and alloys thereof, and may more preferably include Ni, but the present disclosure is not limited thereto.

An average thickness te of the internal electrode 121 and 122 is not particularly limited. The average thickness te of the internal electrode 121 and 122 may be, for example, 0.1 μm to 3.0 μm, 0.1 μm to 1.0 μm, or 0.1 μm to 0.4 μm.

The average thickness td of the dielectric layer 111 and the average thickness te of the internal electrodes 121 and 122 denotes average thicknesses of the dielectric layer 111 and the internal electrodes 121 and 122 in the first direction, respectively. The average thickness td of the dielectric layer 111 and the average thickness te of the internal electrodes 121 and 122 may be measured by scanning the first and second direction cross-sections of the body 110 with a scanning electron microscope (SEM) at 10,000× magnification. More specifically, the average thickness td of the dielectric layer 111 may be measured by measuring thicknesses at multiple points of one dielectric layer 111, for example, at five points equally spaced apart from each other in the second direction, and then taking an average value thereof. Additionally, the average thickness te of the internal electrode 121 and 122 may be measured by measuring thicknesses at multiple points of one internal electrode 121 and 122, for example, at five points equally spaced apart from each other in the second direction, and then taking an average value thereof. The five points equally spaced apart from each other may be designated in a capacitance formation portion Ac. Meanwhile, when the average value measurement is performed for each of 10 dielectric layers 111 and 10 internal electrodes 121 and 122 and then an average value thereof is measured, the average thickness td of the dielectric layer 111 and the average thickness te of the internal electrode 121 and 122 may be further generalized.

The body 110 may include a capacitance formation portion Ac disposed within the body 110, and having a capacitance formed therein by including first and second internal electrodes 121 and 122 disposed alternately with the dielectric layer 111 interposed therebetween, and cover portions 112 and 113 disposed on both surfaces of the capacitance formation portion Ac opposing each other in the first direction. The cover portions 112 and 113 may have a configuration similar to that of the dielectric layer 111, except that the cover portions 112 and 113 do not include an internal electrode.

An average thickness tc of the cover portions 112 and 113 is not particularly limited. The average thickness of the cover portions 112 and 113 may be, for example, 150 μm or less, 100 μm or less, 30 μm or less, or 20 μm or less. The average thickness tc of the cover portions 112 and 113 may be, for example, 5 μm or more, 10 μm or more, or 30 μm or more. Here, the average thickness tc of the cover portions 112 and 113 refers to an average thickness of each of the first cover portion 112 and the second cover portion 113.

The average thickness tc of the cover portions 112 and 113 may refer to an average thickness of the cover portions 112 and 113 in the first direction, and may be an average value of thicknesses in the first direction measured at five points spaced apart from each other by equal intervals in the first and second direction cross sections of the body 110.

The body 110 may include margin portions 114 and 115 disposed on both surfaces opposing each other in the third direction of the capacitance formation portion Ac. The margin portions 114 and 115 may refer a region between both ends of the internal electrodes 121 and 122 and a boundary surface of the body 110 in a cross-section obtained by cutting the body 110 in the first direction and the third direction. The margin portions 114 and 115 may have a similar configuration to the dielectric layer 111 except that the margin portions 114 and 115 do not include the internal electrodes 121 and 122.

An average thickness of the margin portions 114 and 115 is not particularly limited. An average thickness wm of the margin portions 114 and 115 may be, for example, 150 μm or less, 100 μm or less, 20 μm or less, or 15 μm or less. The average thickness wm of the margin portions 114 and 115 may be, for example, 5 μm or more, 10 μm or more, or 30 μm or more. Here, the average thickness wm of the margin portions 114 and 115 refers to an average thickness of each of the first margin portion 114 and the second margin portion 115.

The average thickness wm of the margin portions 114 and 115 may refer to an average thickness of the margin portions 114 and 115 in the third direction, and may be a value obtained by averaging thicknesses in the third direction measured at five points equally spaced apart from each other in the first and third direction cross sections of the body 110.

The external electrodes 131 and 132 may be disposed on the body 110 and connected to the internal electrodes 121 and 122, respectively. The external electrodes 131 and 132 may be disposed on the third and fourth surfaces 3 and 4 of the body 110 and may extend over portions of the first, second, fifth and sixth surfaces 1, 2, 5 and 6. The first external electrode 131 may be disposed on the third surface 3 and may extend over portions of the first, second, fifth and sixth surfaces 1, 2, 5 and 6. The second external electrode 132 may be disposed on the fourth surface 4 and may extend over portions of the first, second, fifth and sixth surfaces 1, 2, 5 and 6.

A region disposed on the third surface 3 of the first external electrode 131 may be defined as a first connection portion CP1, and a region disposed to extend from the first connection portion CP1 to a portion of the first and second surfaces 1 and 2 may be defined as a first band portion BP1. A region disposed on the fourth surface 4 of the second external electrode 132 may be defined as a second connection portion CP2, and a region disposed to extend from a second connection portion CP2 to a portion of the first and second surfaces 1 and 2 may be defined as a second band portion BP2.

The type or shape of the external electrodes 131 and 132 is not particularly limited, and may have a multilayer structure. For example, the external electrodes 131 and 132 may include base electrode layers 131a and 132a connected to the internal electrode 121 and 122 and plating layers 131b and 132b disposed on the base electrode layers 131a and 132a. The plating layers 131b and 132b may be disposed to be in contact with the organic layer 140.

The base electrode layers 131a and 132a may be a sintered electrode layer including a metal and glass. The metal included in the base electrode layers 131a and 132a may include, for example, at least one selected from the group consisting of Cu, Ni, Pd, Pt, Au, Ag, Pb and an alloy including thereof. The glass included in the base electrode layers 131a and 132a may include, for example, one or more oxides selected from the group consisting of Ba, Ca, Zn, Al, B and Si.

Meanwhile, the base electrode layers 131a and 132a may be comprised of only a sintering electrode layer, but the present disclosure is not limited thereto, and the base electrode layers 131a and 132a may include a sintering electrode layer including metal and glass, and a resin electrode layer disposed on the sintering electrode layer and including metal particles and a resin.

The metal particles included in the resin electrode layer may include at least one of spherical particles or flake-shaped particles. The metal particles included in the resin electrode layer may include, for example, at least one selected from the group consisting of Cu, Ni, Pd, Pt, Au, Ag, Pb, Sn, and an alloy including the same. The resin included in the resin electrode layer may include, for example, at least one of epoxy resin, acrylic resin or ethyl cellulose.

The plating layers 131b and 132b may include, for example, at least one selected from the group consisting of Ni, Sn, Pd, and an alloy including the same, and may be formed of a plurality of layers. The plating layers 131b and 132b may be, for example, a Ni plating layer or a Sn plating layer, and may include the Ni plating layer disposed on the base electrode layers 131a and 132a and the Sn plating layer disposed on the Ni plating layer. The plating layers 131b and 132b may include a plurality of Ni plating layers and/or a plurality of Sn plating layers.

The drawings describe a structure in which the multilayer electronic component 100 has two external electrodes 131 and 132, but the present disclosure is not limited thereto, and the number or shape of the external electrodes 131 and 132 may be changed depending on the shape of the internal electrodes 121 and 122 or other purposes.

The organic layer 140 may be disposed on at least a portion of an external surface of the body 110 and at least a portion of an external surface of the external electrodes 131 and 132. The organic layer 140 may include a first organic layer 141 disposed on the body 110 and second organic layers 142 and 143 disposed on the external electrodes 131 and 132.

The first organic layer 141 may be disposed to contact at least a portion of the external surface of the body 110. The first organic layer 141 may be disposed to contact at least one of the first, second, fifth, and sixth surfaces 1, 2, 5 and 6. The first organic layer 141 may be disposed to contact each of the first, second, fifth, and sixth surfaces 1, 2, 5 and 6.

The second organic layers 142 and 143 may be disposed to contact at least a portion of the external surface of the external electrodes 131 and 132. More specifically, the second organic layers 142 and 143 may be disposed to be in contact with at least a portion of the external surface of the plating layers 131b and 132b. The second organic layers 142 and 143 may be disposed to be in contact with the connection portions CP1 and CP2 and/or the band portions BP1 and BP2.

The organic layer 140 may include an organic silicon compound. In the present disclosure, the term “organic silicon compound” may refer to an organic compound having at least one silicon (Si) atom in a molecular structure thereof. The organic layer 140 may basically prevent external moisture from penetrating into the surface of the body 110, thereby suppressing an arc discharge phenomenon of the multilayer electronic component 100 caused by external moisture.

The organic silicon compound included in the organic layer 140 may include, for example, a repeating unit derived from an alkoxysilane represented by the following Chemical Formula 1. The repeating unit derived from an alkoxysilane may refer to a repeating unit having a structure obtained by a hydrolysis reaction and a dehydration condensation reaction of an alkoxysilane. The alkoxysilane may be, for example, an alkyltrialkoxysilane.

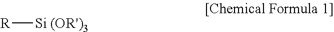

(where R is a C1 to C20 alkyl group, and R′ is a C1 to C6 alkyl group)

The organic silicon compound may have, for example, a siloxane bond (Si—O—Si) formed by a hydrolysis reaction and a dehydration condensation reaction of the alkoxysilane. The organic silicon compound may have, for example, a C1 to C20 alkyl group derived from the alkoxysilane. In an example embodiment, the organic silicon compound may have an alkyl group of C3 to C10. The alkyl group of the organic silicon compound may serve to impart hydrophobic properties to the external surface of the body 110 and/or the external electrodes 131 and 132 to improve the moisture resistance reliability of the multilayer electronic component 100.

According to an example embodiment of the present disclosure, at least a portion of a region of the organic layer 140 disposed on the body 110 (hereinafter referred to as a first region) may have a content of Si element of 2.2 at % or more and 5.8 at % or less with respect to a total element of the organic layer 140, as measured by X-ray photoelectron spectroscopy (XPS). For example, the first organic layer 141 may have a content of Si element of 2.2 at % or more and 5.8 at % or less with respect to a total element of the organic layer 140, as measured by XPS. When the above-described numerical range is satisfied, an arc discharge phenomenon of the multilayer electronic component 100 may be effectively prevented. When the content of the Si element is less than 2.2 at %, the coverage of the organic layer 140 on the body 110 may be insufficient, so that the arc discharge suppression effect of the present disclosure may be minimal. When the content of the Si element exceeds 5.8 at %, the coverage of the organic layer 140 on the body 110 may be excessive, so that static electricity may occur due to the surface adhesiveness of the organic layer 140. Accordingly, a problem in which the multilayer electronic component 100 may not be stably mounted on a printed circuit board (PCB) may occur.

In an example embodiment, an atom ratio of a content of Si element to a content of Ba element measured through XPS (Si/Ba) of the first region may be 0.16 or more and 1.8 or less. When the numerical range is satisfied, the arc discharge phenomenon of the multilayer electronic component 100 may be prevented more effectively.

In an example embodiment, the first region may have an atom ratio of the content of C element to the content of Si element measured through XPS (C/Si) of 2.5 or more and 12.0 or less. The C element measured through XPS may be derived from an R group of the alkoxysilane. When the numerical range is satisfied, the moisture resistance reliability of the multilayer electronic component 100 may be effectively improved while preventing the arc discharge phenomenon of the multilayer electronic component 100. More preferably, the first region may have a ratio of the content of C element to the content of Si element measured through XPS (C/Si) of 5.0 or less.

The contents of the Si, Ba and C elements may be measured based on each peak area of Si2s, Ba3d5 and C1s and a sensitivity coefficient of a measuring device, for example, by etching an external surface of the first organic layer 141 disposed on the first or second surfaces 1 and 2 by 3 nm to 5 nm, and then analyzing a cross-section of an exposed first organic layer 141 by XPS (X-ray type: monochromatic Al-Kα) and removing a background signal. From the measured contents of the Si, Ba and C elements, a ratio (Si/Ba) of a content of the Si element to a content of the Ba element and a ratio (C/Si) of a content of the C element to a content of the Si element may be calculated.

A thickness of the organic layer 140 does not need to be particularly limited. However, an arc discharge phenomenon of the multilayer electronic component 100 may occur due to the lack of insulation of the surface of the body 110 not covered by the first external electrode 131 and the second external electrode 132. Accordingly, in an example embodiment, an average thickness of the organic layer 140 disposed on the body 110 may be thicker than an average thickness of the organic layer 140 disposed on the external electrodes 131 and 132. That is, an average thickness of the first organic layer 141 may be thicker than an average thickness of the second organic layers 142 and 143. As a result, the arc discharge phenomenon of the multilayer electronic component 100 may be effectively suppressed.

An example of measuring the average thickness of the first organic layer 141 will be described. Referring to FIGS. 3 and 5, the first organic layer 141 disposed on the first surface or the second surfaces 1 and 2 of the body 110 in the first and second direction cross-sections of the multilayer electronic component 100 may be analyzed by High-resolution transmission electron microscopy (HRTEM). In the image analyzed by the HRTEM, thicknesses (t1, t3, t5, t7, . . . tn) at five or more points spaced apart from each other among the first organic layer 141 may be measured and then an average value thereof may be regarded as an average thickness of the first organic layer 141.

An example of measuring an average thickness of the second organic layer 142 will be described. Referring to FIGS. 3 and 6, the second organic layer 142 disposed on the connection portions CP1 and CP2 in the first and second direction cross-sections of the multilayer electronic component 100 may be analyzed by the HRTEM. In the image analyzed by the HRTEM, thicknesses (t2, t4, t6, t8, . . . tm) at five or more points spaced apart from each other among the second organic layer 142 may be measured, and then, an average value thereof may be regarded as an average thickness of the second organic layer 142.

An average thickness of the organic layer 140 disposed on the body 110, i.e., an average thickness of the first organic layer 141, is not particularly limited, but may be, for example, 5 nm or more and 15 nm or less. When the average thickness of the first organic layer 141 is less than 5 nm, the coverage of the organic layer 140 on the body 110 may not be sufficient, and thus the arc discharge suppression effect of the present disclosure may be minimal. When the average thickness of the first organic layer 141 exceeds 15 nm, there may be a concern that the mounting stability of the multilayer electronic component 100 may be reduced due to static electricity generated by the organic layer 140 because the coverage of the organic layer 140 on the body 110 is excessive.

Referring to FIGS. 5 and 6, the first organic layer 141 may be discontinuously disposed on the body 110, and the second organic layer 142 may be discontinuously disposed on the external electrode 131. In an example embodiment, a coverage of the first organic layer 141 may be greater than a coverage of the second organic layer 142. Accordingly, it may be possible to more effectively suppress the arc discharge phenomenon of the multilayer electronic component 100.

The coverage of the first organic layer 141 may refer to a ratio of a total length of a portion of the surface of the body 110 covered by the first organic layer 141 to a total length of the surface of the body 110 in a given region. The coverage of the second organic layer 142 may refer to a ratio of a total length of a portion of a surface of the external electrodes 131 and 132 covered by the second organic layers 142 and 143 to the total length of the surface of the external electrodes 131 and 132 in a given region.

Micropores (MP) may exist on a surface of the body 110. The body 110 may have the properties of a sintered body. Accordingly, unlike the plating layers 131b and 132b having a relatively high density, the micropores (MP) may exist on the surface of the body 110. Since external moisture may penetrate into the body 110 through the micropores (MP), the micropores (MP) may be a factor deteriorating the moisture resistance reliability of the multilayer electronic component 100. According to an example embodiment of the present disclosure, the organic layer 140 may fill the inside of the micropores (MP). That is, the first organic layer 141 may fill the inside of the micropores (MP). Accordingly, it may be possible to improve the moisture resistance reliability of the multilayer electronic component 100.

In an example embodiment, when the surface roughness of the surface of the organic layer 140 in contact with the body 110 is defined as R1, and the surface roughness of the surface of the organic layer 140 in contact with the external electrodes 131 and 132 is defined as R2, R1>R2 may be satisfied. That is, a surface roughness R1 of the surface of the first organic layer 141 in contact with the body 110 may be greater than a surface roughness R2 of surfaces of the second organic layers 142 and 143 in contact with the external electrodes 131 and 132. Here, the surface roughness may refer to a centerline average roughness Ra measured using an Atomic Force Microscope (AFM) device. An external surface of the body 110 having the properties of a sintered body may be rougher than the plating layers 131b and 132b. Accordingly, R1>R2 may be satisfied.

Meanwhile, a size of the multilayer electronic component 100 is not particularly limited. However, the arc discharge phenomenon of the multilayer electronic component 100 may occur when a high voltage is applied to the multilayer electronic component 100, and specifically, when the multilayer electronic component 100 has a size of 1005 size (length: about 1.0 mm, width: about 0.5 mm, thickness: about 0.5 mm) or more, there is a high risk that the arc discharge phenomenon may occur. Accordingly, when the multilayer electronic component 100 according to an example embodiment of the present disclosure is applied to a high-voltage electric field component having a size of 1005 size (length: about 1.0 mm, width: about 0.5 mm, thickness: about 0.5 mm) or more, the reliability improvement effect may be more remarkable.

Hereinafter, an example of a method of forming the multilayer electronic component 100 will be described.

However, the method for manufacturing the multilayer electronic component 100 is not limited thereto.

First, ceramic powder particles for forming a dielectric layer 111 are prepared. The ceramic powder particles may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ) (Zr_{1-y}Ti_{y})O₃ (0<x≤0.5, 0<y≤0.5). The BaTiO₃ powder particles may be synthesized, for example, by reacting a titanium raw material such as titanium dioxide with a barium raw material such as barium carbonate. Examples of methods of synthesizing the ceramic powder particles include a solid-state method, a sol-gel method and a hydrothermal synthesis method, but the present disclosure is not limited thereto. Next, after drying and pulverizing the prepared ceramic powder particles, an organic solvent such as ethanol and a binder such as polyvinyl butyral are mixed to prepare a ceramic slurry, and the ceramic slurry is applied and dried on a carrier film to prepare a ceramic green sheet.

Next, an internal electrode conductive paste including metal powder particles, a binder and an organic solvent is printed on the ceramic green sheet at a predetermined thickness, using a screen printing method or a gravure printing method to form an internal electrode pattern.

Then, the ceramic green sheet on which the internal electrode pattern is printed is peeled off from a carrier film, and the ceramic green sheets on which the internal electrode pattern is printed are stacked and pressurized to form a ceramic laminate in a predetermined number of layers. In order to form cover portions 112 and 113 after sintering, a ceramic green sheet on which the internal electrode pattern is not formed may be stacked in a predetermined number of layers on upper and lower portions of the ceramic laminate. Then, the ceramic laminate may be cut to have a predetermined chip size, and the cut chip may be sintered at a temperature of 1000° C. or more and 1400° C. or less, thus forming a body 110.

Meanwhile, the margin portions 114 and 115 may be formed by applying and sintering a conductive paste for internal electrodes on the ceramic green sheet except for a region in which the margin portion is to be formed. Alternatively, in order to suppress a step portion caused by the internal electrode 121 and 122, after cutting the ceramic laminate so that the internal electrode pattern is exposed on both surfaces of the cut chip in the third direction, a sheet for forming the margin portion may be attached to both surfaces of the cut chip in the third direction, and then sintered to form the margin portions 114 and 115.

Next, the external electrodes 131 and 132 are formed. For example, when the base electrode layers 131a and 132a includes a sintered electrode layer, the body 110 may be dipped in a conductive paste for external electrodes including metal powder particles, glass frit, a binder, and an organic solvent, and then a conductive paste for external electrodes may be sintered at a temperature of 500° C. to 900° C., thus forming the sintered electrode layer.

For example, when the base electrode layers 131a and 132a includes a resin electrode layer, the body may be dipped in a conductive resin composition including metal powder particles, a resin, a binder and an organic solvent, and then the body may be cured and heat-treated at a temperature of 250° C. to 550° C., thus forming the resin electrode layer.

Additionally, an electrolytic plating method and/or an electroless plating method may be additionally performed to form a plating layers 131b and 132b on the base electrode layers 131a and 132a.

Next, an organic coating solution may be applied to cover the surface of the body 110 and the surfaces of the external electrodes 131 and 132, or the body 110 on which the external electrodes 131 and 132 are formed may be immersed in the organic coating solution. Then, the body 110 on which the external electrodes 131 and 132 are formed may be dried to form an organic layer 140. A drying temperature is not particularly limited, but may be, for example, 100° C. to 200° C.

An organic coating solution may include an alkoxysilane represented by R—Si(OR′)₃ (where R is an alkyl group of C1 to C20 and R′ is an alkyl group of C1 to C6) and a solvent such as an alcohol. A weight of the alkoxysilane among the total weight of the organic coating solution may be 1 wt % or more and 15 wt % or less, but the present disclosure is not limited thereto.

Referring to FIG. 7, a formation process of the organic layer is described in detail. First, the alkoxysilane may be dissolved in a solvent such as alcohol to form an organic coating solution (Si). In this process, the alkoxy group (Si—OR′) of the alkoxysilane may be hydrolyzed to convert into a silanol group (Si—OH), and a siloxane bond (Si—O—Si) may be formed (S2). When the organic coating solution is applied to a surface of the multilayer electronic component 100, or the multilayer electronic component 100 is immersed in the organic coating solution, a hydroxyl group (—OH) and a silanol group (Si—OH) present on the surface of the multilayer electronic component 100 may form a hydrogen bond (S3). Then, a covalent bond may be formed between the organic silicon compound and the multilayer electronic component 100 by a dehydration condensation reaction by heating and drying, thereby forming an organic layer (S4).

Meanwhile, in order to control an average thickness of the first organic layer 141 and an average thickness of the second organic layers 142 and 143, the first organic layer 141 and the second organic layers 142 and 143 may be formed separately. For example, a first organic coating solution may be applied and dried only on an external surface of the body 110 using a mask or the like to form the first organic layer 141, and then the second organic coating solution may be applied and dried only on external surfaces of the external electrodes 131 and 132 using a mask or the like to form second organic layers 142 and 143. For example, a weight ratio of the alkoxysilane in a total weight of the first organic coating solution may be greater than a weight ratio of the alkoxysilane in a total weight of the second organic coating solution. Accordingly, the average thickness of the first organic layer 141 may be made thicker than the average thickness of the second organic layers 142 and 143.

### (Inventive Example)

After preparing a sample chip of size 1005 (length: approximately 1.0 mm, width: approximately 0.5 mm, thickness: approximately 0.5 mm), the moisture resistance reliability was evaluated according to the presence or absence of the organic layer. An average thickness of the first organic layer of the inventive example was 10 nm. A comparative example did not form an organic layer. The average thickness of the first organic layer was calculated by analyzing and measuring thicknesses, by using the HRTEM, at five points spaced apart from each other in a cross section of the sample chip in the first and second directions, polished to a central portion of the sample chip in the third direction, and then obtaining an average value thereof.

First, for each of 20 samples of the inventive example and the comparative example, the voltage at the moment when the current value becomes 10 mA under the boosting conditions of 25° C. and 400 V/s was measured as a breakdown voltage (BDV), and an average value thereof was recorded in Table 1 below.

A moisture resistance reliability evaluation was conducted on 400 samples each of inventive and comparative examples, and when a reference voltage (1 Vr) was applied for 24 hours under the conditions of temperature 85° C. and relative humidity 85%, samples whose insulation resistance decreased by 1/10 or less as compared to an initial value were determined as defective and are listed in Table 1 below.

TABLE 1

| Division | Inventive Example | Comparative Example |
|---|---|---|
| BDV | 5,060 V | 6,640 V |
| Moisture Resistance | 0/400 | 2/400 |
| Reliability | | |

Referring to Table 1 above, it may be confirmed that when an organic layer is formed, the breakdown voltage (BDV) and moisture resistance reliability of the multilayer electronic component are improved.

Although an example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the technical concept of the present disclosure defined by the appended claims, and these replacements, modifications, or changes should be construed as being included in the technical concept of the present disclosure.

Additionally, the expression ‘an example embodiment’ used in the present disclosure does not mean the same embodiment, and is provided to emphasize and explain different unique characteristics. However, the example embodiments presented above do not preclude being implemented in combination with the features of another embodiment. For example, although items described in a specific example embodiment are not described in another example embodiment, the items may be understood as a description related to another example embodiment unless a description opposite or contradictory to the items is in another example embodiment.

In the present disclosure, a meaning of being connected is a concept including not only directly connected but also indirectly connected through an adhesive layer or the like. Furthermore, a meaning of electrically connected is a concept including both physically connected and not connected. In addition, expressions such as first and second are used to distinguish one component from another, and do not limit the order and/or importance of the components. In some cases, a first component may be referred to as a second component without departing from the scope of rights, or similarly, the second component may be referred to as the first component.

What is claimed is:

1. A multilayer electronic component, comprising:
a body including a dielectric layer and an internal electrode alternately disposed with the dielectric layer;
an external electrode disposed on the body and connected to the internal electrode; and
an organic layer disposed on at least a portion of an external surface of the body and at least a portion of an external surface of the external electrode, and including an organic silicon compound,
wherein in at least a portion of the organic layer disposed on the body, a content of Si element measured by a X-ray photoelectron spectroscopy (XPS) is 2.2 at % or more and 5.8 at % or less with respect to a total element of the organic layer.

2. The multilayer electronic component according to claim 1, wherein the region has an atom ratio (Si/Ba) of the content of Si element to a content of Ba element (Si/Ba) measured by the XPS is 0.16 or more and 1.8 or less.

3. The multilayer electronic component according to claim 1, wherein the region has an atom ratio (C/Si) of a content of C element to a content of Si element measured through the XPS of 2.5 or more and 12.0 or less.

4. The multilayer electronic component according to claim 3, wherein the region has the atom ratio (C/Si) of the content of the C element to the content of the Si element measured through the XPS of 5.0 or less.

5. The multilayer electronic component according to claim 1, wherein the organic silicon compound has a siloxane bond.

6. The multilayer electronic component according to claim 1, wherein the organic silicon compound has an alkyl group of C1 to C20.

7. The multilayer electronic component according to claim 1, wherein an average thickness of the organic layer disposed on the body is thicker than an average thickness of the organic layer disposed on the external electrode.

8. The multilayer electronic component according to claim 1, wherein an average thickness of the organic layer disposed on the body is 5 nm or more and 15 nm or less.

9. The multilayer electronic component according to claim 1, wherein micropores exist on a surface of the body, and
the organic layer fills an inside of the micropores.

10. The multilayer electronic component according to claim 1, wherein when a surface roughness of a surface of the organic layer in contact with the body is defined as R1 and a surface roughness of a surface of the organic layer in contact with the external electrode is defined as R2,
R1>R2 is satisfied.

11. The multilayer electronic component according to claim 1, wherein the organic layer includes a first organic layer discontinuously disposed on the body and a second organic layer discontinuously disposed on the external electrode.

12. The multilayer electronic component according to claim 1, wherein the external electrode includes a base electrode layer connected to the internal electrode and a plating layer disposed on the base electrode layer and disposed to be in contact with the organic layer.

13. The multilayer electronic component according to claim 12, wherein the plating layer includes a Ni plating layer disposed on the base electrode layer and a Sn plating layer disposed on the Ni plating layer.

14. The multilayer electronic component according to claim 1, wherein the organic silicon compound included a repeating unit derived from an alkoxysilane represented by the following Chemical Formula 1: 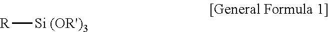
Wherein, in Chemical Formula 1,
R is a C1 to C20 alkyl group, and
R′ is a C1 to C6 alkyl group.
